(19) United States
(12) Patent Application Publication
(10) Pub. No.: US 2018/0176789 A1
(43) Pub. Date: Jun. 21, 2018

(54) SPATIAL REUSE PPDU INDICATION

(71) Applicant: AVAGO TECHNOLOGIES GENERAL IP( SINGAPORE) PTE LTD., Singapore (SG)

(72) Inventor: Matthew J. FISCHER, Mountain View, CA (US)

(73) Assignee: AVAGO TECHNOLOGIES GENERAL IP( SINGAPORE) PTE LTD., Singapore (SG)

(21) Appl. No.: 15/797,272

(22) Filed: Oct. 30, 2017

Related U.S. Application Data
(60) Provisional application No. 62/498,135, filed on Dec. 16, 2016.

(51) Int. Cl. H04W 16/14; H04L 5/00; H04L 29/08; H04W 52/32; H04W 72/08

(52) U.S. Cl. CPC H04W 16/14; H04L 5/0055; H04W 84/12; H04W 52/325; H04W 72/082; H04L 69/323

(57) ABSTRACT

A wireless communication device includes an antenna circuit to receive communications over a communication medium, and circuitry coupled to the antenna circuit. The circuitry receives, via the antenna circuit, a physical layer convergence protocol protocol data unit (PPDU) transmission from another device, and determine whether the PPDU transmission is a spatial reuse (SR) transmission. The circuitry determines whether one or more SR transmission conditions are met when the PPDU transmission is an SR transmission. The circuitry transmits an acknowledgement message to the other device when the one or more SR transmission conditions are met.

### CROSS-REFERENCE TO RELATED APPLICATIONS

This application claims the benefit of U.S. Provisional Application No. 62/498,135 entitled “Spatial Reuse PPDU Indication” and filed Dec. 16, 2016. The entire contents of this provisional application are hereby incorporated by reference.

### BACKGROUND

### Technical Field

The present disclosure relates generally to communication systems; and, more particularly, to channel sharing and concurrent communications within single user, multiple user, multiple access, and/or MIMO wireless communications.

### Description of the Related Art

Communication systems support wireless and wire lined communications between wireless and/or wire lined communication devices. The systems can range from national and/or international cellular telephone systems, to the Internet, to point-to-point in-home wireless networks and can operate in accordance with one or more communication standards. For example, wireless communication systems may operate in accordance with one or more standards including, but not limited to, IEEE 802.11x (where x may be various extensions such as a, b, n, g, etc.), Bluetooth, advanced mobile phone services (AMPS), digital AMPS, global system for mobile communications (GSM), etc., and/or variations thereof.

In some instances, wireless communication is made between a transmitter (TX) and receiver (RX) using single-input-single-output (SISO) communication. Another type of wireless communication is single-input-multiple-output (SIMO) in which a single TX processes data into RF signals that are transmitted to a RX that includes two or more antennae and two or more RX paths.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a diagram of a wireless communication system in accordance with exemplary aspects of the present disclosure;

FIG. 2 is a diagram of dense deployment of wireless communication devices;

FIG. 3 is a diagram of communication between wireless communication devices according to exemplary aspects of the present disclosure;

FIG. 4 is a diagram of stations (STAs) configured to operate with spatial reuse (SR) in accordance with exemplary aspects of the present disclosure;

FIG. 5 is a diagram of a media access control (MAC) frame format in accordance with exemplary aspects of the present disclosure;

FIG. 6 is a diagram of high throughput (HT) control fields for HT, very high throughput (VHT), and high efficiency (HE) variants according to exemplary aspects of the present disclosure;

FIG. 7 is a diagram of a HT control middle subfield of a HT variant HT control field according to exemplary aspects of the present disclosure;

FIG. 8 is a diagram of a VHT control middle subfield of a VHT variant HT control field in accordance with exemplary aspects of the present disclosure;

FIG. 9 is a diagram of an aggregated control (A-control) subfield of a HE variant HT control field according to exemplary aspects of the present disclosure; and

FIG. 10 is an algorithmic flowchart of a communication process in accordance with exemplary aspects of the present disclosure.

### DETAILED DESCRIPTION

In a wireless local area network (WLAN) system in which a central controller makes decisions about which device may access a communication medium, resources are allocated after consideration of competing resource requests from participating stations (STAs). The central controller (e.g., access point) provides resource units for each given phase of data exchange, where each phase of data exchange may provide resource units to more than one participating station (STA) corresponding to a single window of time. The resource units for different STAs are orthogonal through various means, e.g. frequency orthogonal, spatially orthogonal, etc. In each of the allocated resource units, an access point (AP) or a non-AP STA may transmit an aggregated media access control (MAC) protocol data unit (A-MDPU) in a single user physical layer convergence protocol (PLCP) protocol data unit (PPDU) or multi-user PPDU to the intended recipient STA for efficiency improvement. The allocated resource unit can be a fragment or a whole operating channel of the AP. In some implementations, an AP with all associated STAs can be referred to as a basic service set (BSS).

During the period of time of such PPDU transmissions, another pair of STAs in a different BSS, such as an overlapping BSS (OBSS), may transmit if the generated interference is under a predetermined level or other predetermined criteria have been met, which is referred to as spatial reuse (SR). Aspects of the present disclosure are directed to a mechanism for facilitating SR operations by providing a SR PPDU indication so that STAs within a BSS are aware of when another STA within the BSS is performing SR operations with STAs of another BSS.

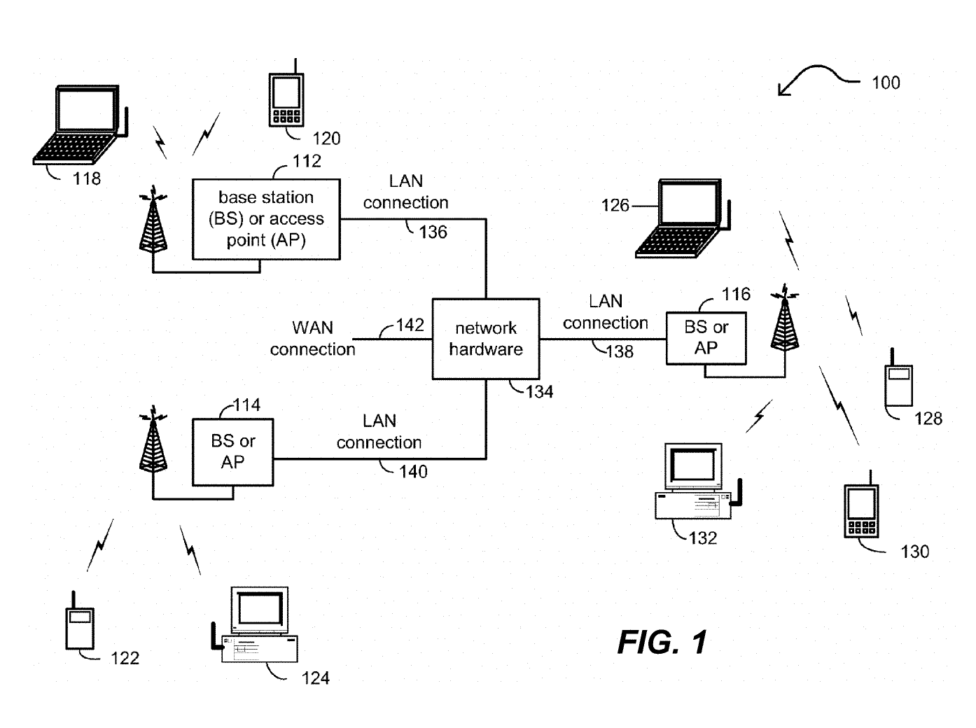

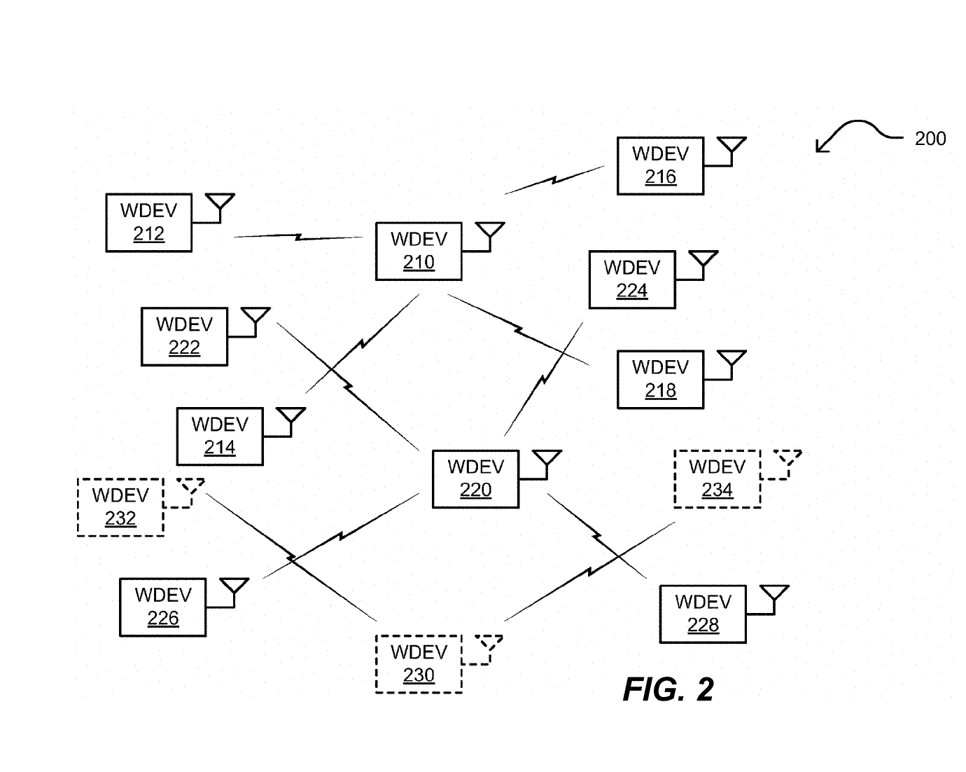

FIG. 1 is a diagram illustrating a wireless communication system 100 in accordance with exemplary aspects of the present disclosure. The wireless communication system 100 includes base stations and/or access points 112-116, wireless communication devices 118-132 (e.g., wireless stations (STAs)), and a network hardware component 134. The wireless communication devices 118-132 may be laptop computers, or tablets, 118 and 126, personal digital assistants 120 and 130, personal computers 124 and 132 and/or cellular telephones 122 and 128. The details of an exemplary hardware structure of such wireless communication devices are described in greater detail with reference to FIG. 2.

The base stations (BSs) or access points (APs) 112-116 are operably coupled to the network hardware 134 via local area network connections 136, 138, and 140. The network hardware 134, which may be a router, switch, bridge, modem, system controller, etc., provides a wide area network connection 142 for the communication system 100. Each of the base stations or access points 112-116 has an associated antenna or antenna array to communicate with the wireless communication devices in its area. Typically, the wireless communication devices register with a particular base station or access point 112-116 to receive services from the communication system 100. For direct connections (i.e., point-to-point communications), wireless communication devices communicate directly via an allocated channel.

Any of the various wireless communication devices (WDEVs) 118-132 and BSs or APs 112-116 may include circuitry, such as a processor and a communication interface circuit, to support communications with any other of the wireless communication devices 118-132 and BSs or APs 112-116.

In an example of operation, a processor of one of the devices (e.g., any one of the WDEVs 118-132 and BSs or APs 112-116) is configured to process a first signal received from another one of the devices (e.g., any other one of the WDEVs 118-132 and BSs or APs 112-116) to determine one or more concurrent transmission parameters. The processor then generates a second signal based on the one or more concurrent transmission parameters and directs a communication interface of the device to transmit the second signal during receipt of the first signal. The first signal that is detected or received includes one or more concurrent transmission parameters therein. These one or more concurrent transmission parameters may be explicitly signaled within the first signal or determined implicitly based on one or more characteristics of the first signal. The communication interface of the device receives the first signal from a first other device, and transmits the second signal to a second other device.

The device is configured to transmit the second signal to the second other device during transmission of the first signal by the first other device. The one or more concurrent transmission parameters included within the first signal provide information by which the device can make the transmission of the second signal. Certain implementations operate making a trade-off in terms of how much interference the first signal can tolerate in comparison to how much protection the second signal will need. The device may then begin transmitting the second signal during the time in which the first other device is transmitting the first signal based on the one or more concurrent transmission parameters.

FIG. 2 is a diagram illustrating a dense deployment 200 of wireless communication devices (shown as WDEVs in the diagram). Any of the various WDEVs 210-234 may be access points (APs) or wireless stations (STAs). For example, WDEV 210 may be an AP or an AP-operative STA that communicates with WDEVs 212, 214, 216, and 218 that are STAs. WDEV 220 may be an AP or an AP-operative STA that communicates with WDEVs 222, 224, 226, and 228 that are STAs. In certain instances, one or more additional APs or AP-operative STAs may be deployed, such as WDEV 230 that communicates with WDEVs 232 and 234 that are STAs. The STAs may be any type of wireless communication devices such as wireless communication devices 118-132, and the APs or AP-operative STAs may be any type of wireless communication devices such as BSs or APs 112-116. Different groups of the WDEVs 210-234 may be partitioned into different basic services sets (BSSs). In some instances, one or more of the WDEVs 210-234 are included within one or more overlapping basic services sets (OBSSs) that cover two or more BSSs. As described above with the association of WDEVs in an AP-STA relationship, one of the WDEVs may be operative as an AP and certain of the WDEVs can be implemented within the same basic services set (BSS).

This disclosure presents novel architectures, methods, approaches, etc. that allow for improved spatial re-use (SR) for next generation WiFi (e.g., IEEE 802.11ax) and wireless local area network (WLAN) systems. Next generation WiFi systems are expected to improve performance in dense deployments where many clients and AP are packed in a given area (e.g., which may be a relatively area, i.e., indoor or outdoor, with a high density of devices, such as a train station, airport, stadium, building, shopping mall, etc. to name just some examples). Large numbers of devices operating within a given area can be problematic if not impossible using prior technologies.

Within such wireless systems, communications may be made using orthogonal frequency division multiplexing (OFDM) and/or orthogonal frequency division multiple access (OFDMA) signaling. OFDM's modulation may be viewed as dividing an available spectrum into a plurality of narrowband sub-carriers that can, for example, have a relatively lower data rate. The sub-carriers are included within an available frequency spectrum portion or band. This available frequency spectrum is divided into the sub-carriers, or tones, used for the OFDM or OFDMA symbols and frames. Typically, the frequency responses of these sub-carriers are non-overlapping and orthogonal. Each sub-carrier may be modulated using any of a variety of modulation coding techniques. Comparing OFDMA to OFDM, OFDMA is a multi-user version of the OFDM signaling scheme. Multiple access is achieved in OFDMA by assigning subsets of subcarriers to individual recipient devices or users. For example, first sub-carrier(s)/tone(s) may be assigned to a user 1, second sub-carrier(s)/tone(s) may be assigned to a user 2, and so on up to any desired number of users. As can be appreciated the specific number of users is not limiting upon the present disclosure.

In the context of such a dense deployment of wireless communication devices, any one of the WDEVs 210-234 may include a processor that is configured to process a first signal received from another one of the devices (e.g., any other one of the WDEVs 210-234) to determine one or more concurrent transmission parameters. Note that this first signal may be intended for a particular one of the WDEVs 210-234 and yet may be detected or received by one or more other of the WDEVs 210-234. The processor of a WDEV that may not be specifically designated as a recipient of the first signal generates a second signal based on those one or more concurrent transmission parameters and directs a communication interface of the device to transmit the second signal during receipt of the first signal.

Examples of such concurrent transmission parameters may include information corresponding to at least one of a modulation type, a coding type, a modulation coding set (MCS), a transmit or receive power level, a duration of the first signal, a frame type of the first signal, uplink or downlink indication, an interference margin level, a basic services set (BSS) identifier, a transmitter or receiver identifier, a number of spatial streams, a number or transmitter or receiver antennae, symbol timing and carrier frequency offset, a concurrent transmission start time, a concurrent transmission end time, and a carrier sense threshold. Any one or more of these concurrent transmission parameters may be indicated explicitly within the first signal or determined by processing the first signal. For example, any one of the one or more concurrent transmission parameters may be determined implicitly by processing the first signal. The one or more concurrent transmission parameters may be characteristics or features of the first signal, and a device's processor may be configured to determine those parameters implicitly by analyzing the characteristics or features of the first signal.

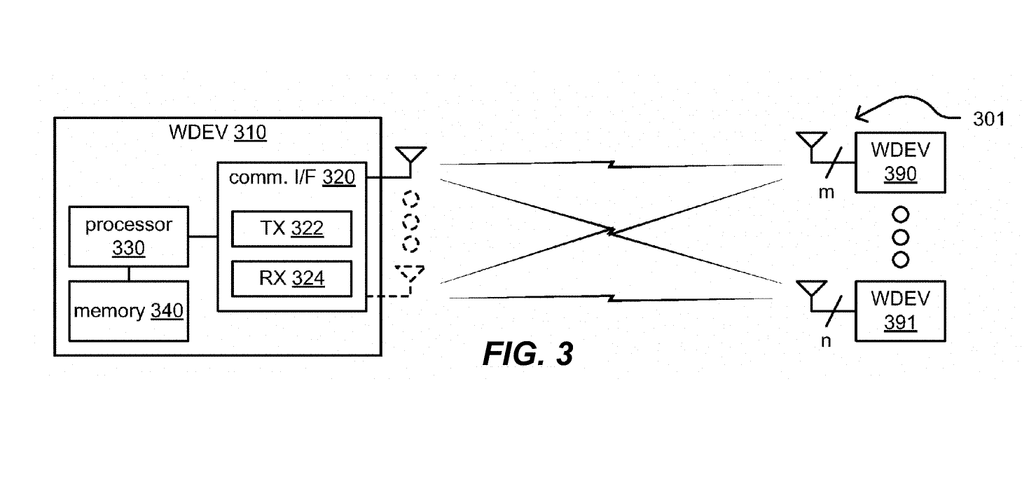

FIG. 3 is a diagram illustrating an example 301 of communication between wireless communication devices. A wireless communication device 310 (e.g., which may be any one of devices 118-132 as with reference to FIG. 1) is in communication with another wireless communication device 390 via a communication medium. The wireless communication device 310 includes a communication interface circuit 320 to perform transmitting and receiving of one or more frames (e.g., using a transmitter 322 and a receiver 324). The wireless communication device 310 also includes a processor 330 with circuitry configured to execute one or more software instructions stored in an associated memory 340, to execute various operations including interpreting one or more frames transmitted to wireless communication device 390 and/or received from the wireless communication device 390 and/or wireless communication device 391. The wireless communication devices 310 and 390 may be implemented using one or more integrated circuits in accordance with any desired configuration or combination or components, modules, etc., within one or more integrated circuits. For example, the wireless communication devices 310 may be implemented as a system on a chip (SoC) or using discrete logic and analog circuits. Implementations using field programmable gate arrays (FPGA's) and/or application specific integrated circuits (ASIC's) are also possible without departing from the scope of the present disclosure. Also, the wireless communication devices 310, 390, and 391 may each include more than one antenna for transmitting and receiving of one or more frames (e.g., WDEV 390 may include m antennae, and WDEV 391 may include antennae).

In a WLAN system where limited channels of operation exist and must be shared by multiple WLAN BSSs, a basic channel sharing mechanism that allows one pair of devices to operate at any given time is inefficient because other devices that detect the operation of the pair must defer to that pair. A more efficient channel sharing mechanism allows multiple pairs of devices to operate simultaneously. Such a mechanism is referred to as Spatial Reuse (SR).

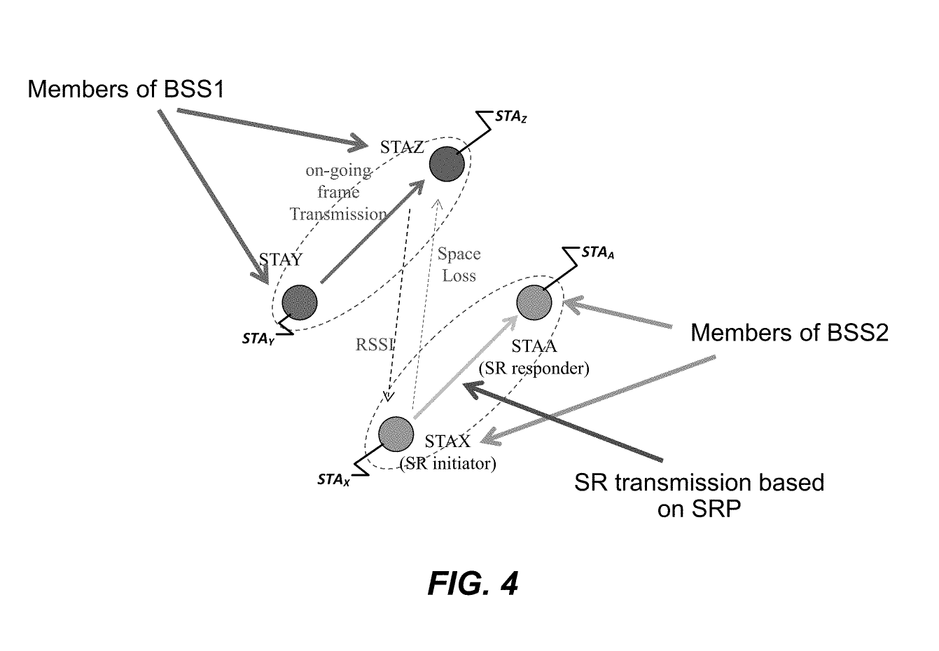

FIG. 4 is an exemplary diagram of stations (STAs) configured to operate with spatial reuse (SR) and can implement one or more SR techniques. One SR technique allows a STA_{X} to examine the relative receive powers of a sequence of frame exchanges between two other STAs, e.g. STA_{Y}, STA_{Z} and then allows STA_{X} to transmit if STA_{X} can determine that a transmission from STA_{N} will not interfere with the transmissions between STA_{Y} and STA_{Z} based on the measured receive power values and additional information that is delivered within the PHY header(s) of additional frame(s) transmitted between STA_{Y} and STA_{Z}. This technique is called Spatial Reuse Parameterized (SRP).

The SR technique may also use a varying threshold of detection which is applied to the transmissions from other STAs and relies on general assumptions about mutual interference in order to make a less robust assessment of whether it may proceed with its own transmission. This technique is called OBSS_PD SR, where OBSS_PD refers to a preamble detection threshold to OBSS PPDUs.

In the SR techniques described herein, an underlying assumption is that most transmissions include the AP of a BSS as one of the STA in the pair of STAs that are exchanging PPDUs. Therefore, the SR techniques discussed herein refer to SR among pairs of STAs which are members of different BSSs, i.e. they are OBSS devices and their transmissions are OBSS transmissions, i.e. OBSS PPDUs. Also, in one example, an SR transmission can be performed during an OBSS PPDU transmission and not during the transmission of a PPDU by another member of the same BSS. In another example, an SR transmission may be made during PPDU transmission of another member of the same BSS provided the frame includes information to allow the recipient to determine the source and destination. This way the recipient can determine whether its subsequent transmission will be directed towards either the source or destination of the earlier transmission. Such information may be included in, for example, an entire 802.11 frame such as in the MAC portion. Other variations are also possible as one of ordinary skill would recognize.

When employing either SR technique, the spatial reuse condition that is initially determined (i.e. SRP) or estimated (i.e. OBSS_PD) to be met before a spatial reuse transmission may be initiated is whether the SR initiator, e.g. STA_{X} in the previous example, will interfere with the reception of a PPDU transmitted between STA_{Y} and STA_{Z}. Provided that this condition is met, then STA_{N} proceeds with the transmission of a PPDU that is generally restricted to completing before the end of the OBSS PPDU over which it is transmitting. When the SR condition is met, STA_{X} has established an SR opportunity. In some implementations, one mechanism that potentially allows STA_{N} to meet the SR condition is to reduce transmit power of STA_{N}, which can have an effect of reducing potential interference to the original (first) PPDU exchange and might allow STA_{N} to meet the overall SR requirement of not interfering with the original exchange.

Two complications arise when SR is performed in a WLAN since in WLAN an acknowledgement PPDU is transmitted following the transmission of a DATA-bearing PPDU addressed to a single recipient. In some examples, the STA_{Z} transmission of its acknowledgement may fail at the STA_{Y} location because of an ongoing STA_{N} SR PPDU transmission. This problem is solved by restricting the STA_{N} SR PPDU transmission to occur within a time limit not to exceed the duration of the STA_{Y} PPDU.

In addition, a response to the STA_{N} SR transmission, e.g., the acknowledgement transmitted by STA_{A} may interfere with the STA_{Z} reception of the original PPDU, which can be referred to as acknowledgement-induced interference. Exemplary aspects of the present disclosure are directed to providing a solution to this problem. For example, STA_{A}, which is the STA within the same BSS as STA_{X}, can check for a SR condition before committing to transmission of an acknowledgement message. If the SR condition is met, STA_{A} can transmit the acknowledgement. If the SR condition is not met, STA_{A} does not transmit the acknowledgement.

In other exemplary aspects, STA_{A} monitors the communication medium for PPDU transmissions. For any OBSS PPDU transmission it receives, STA_{A} tracks whether or not there is an opportunity for SR. For example, if STA_{A} receives a transmission from STA_{X}, STA_{A} may determine whether the STA_{N} transmission was sent during an SR opportunity or not. If the STA_{N} transmission was not sent during an SR opportunity, STA_{A} may transmit an acknowledgement without regard to any other ongoing activity. If the STA_{X} transmission was sent during a SR opportunity, STA_{A} may determine whether the transmission of an acknowledgement will cause interference, and transmit the acknowledgement if no interference will be caused to any other ongoing exchange. For example, if STA_{X} meets any outstanding SR conditions which can include that STA_{N} either observes that there is no other outstanding exchange or the STA_{N} acknowledgement transmission made by STA_{A} meets the SR conditions that it observes.

During an SR opportunity, then STA_{A} is only permitted to transmit an acknowledgement if the STA_{A} transmission does not cause interference to any other ongoing exchange. In addition or in the alternative to meeting any outstanding SR conditions, other conditions can be imposed on STA_{N} transmission of an acknowledgement to a PPDU sent during an SR opportunity by STA_{A}. For example, any combination of the following conditions may be imposed on the STA transmitting an acknowledgement message corresponding to a PPDU sent during an SR opportunity:
STA_{N} or STA_{A} meets SRP conditions for an acknowledgement transmission;
STAx or STA_{A} adheres to the OBSS_PD transmit power restriction, if any is active at the time of the acknowledgement transmission;
STAx of STA_{A} examines physical energy detect and does not transmit the acknowledgement if BUSY is indicated; and/or
STAx or STA_{A} examines a virtual carrier detect (i.e. NAV) condition and does not transmit the acknowledgement if BUSY is indicated.

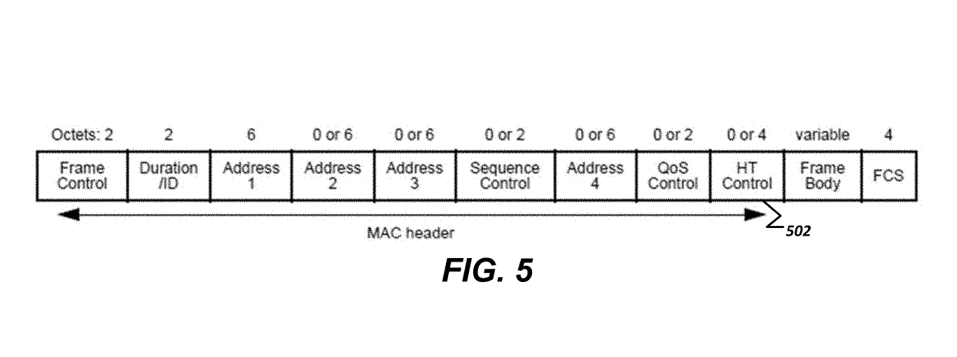

In order for STA_{A} to determine whether to respond with an acknowledgement transmission, STA_{A} determines whether the PPDU received by STA_{A} was transmitted during a SR opportunity. The determination of whether a PPDU was transmitted during an SR opportunity can be made explicit by including an indication within a PPDU transmission that the PPDU was transmitted during an SR opportunity. In one aspect, the PPDU is a data-carrying PPDU, but a control PPDU that does not carry payload data may also be used as one of ordinary skill would recognize. For example, FIG. 5 is an exemplary diagram of a media access control (MAC) frame format for a PPDU. In some implementations, the SR PPDU transmission indication is provided in high throughput (HT) control field 502. However, indication that the PPDU is sent during an SR opportunity need not be limited to the HT control field. Such an indication may also be placed in the frame body, the frame control fields, etc., as one of ordinary skill would recognize.

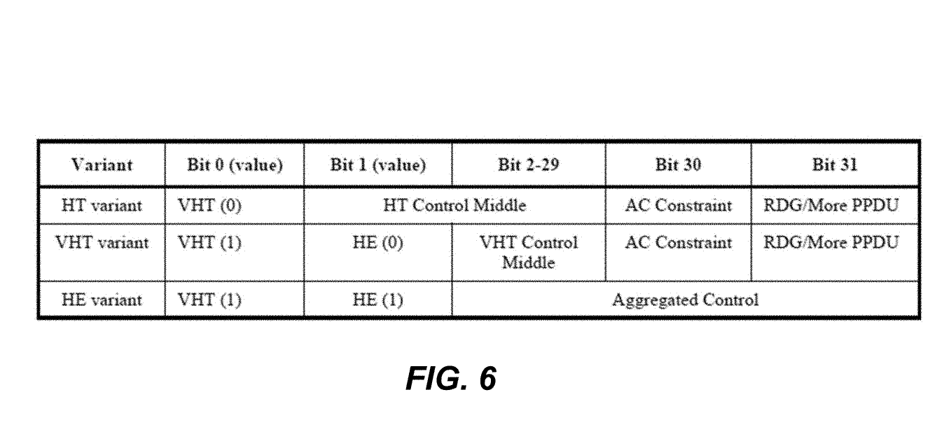

FIG. 6 is an exemplary diagram of high throughput (HT) control fields for HT, very high throughput (VHT), and high efficiency (HE) variants. As can be seen from the diagram, the HE variant uses aggregated control, which can also be referred to as A-control. A single bit may be added to the HT control middle field of HT and VHT variants, or the A-control field in the case of the HE variant, as described in detail below. However, the single bit may be added to other fields of the HT control field without departing from the scope of the present disclosure.

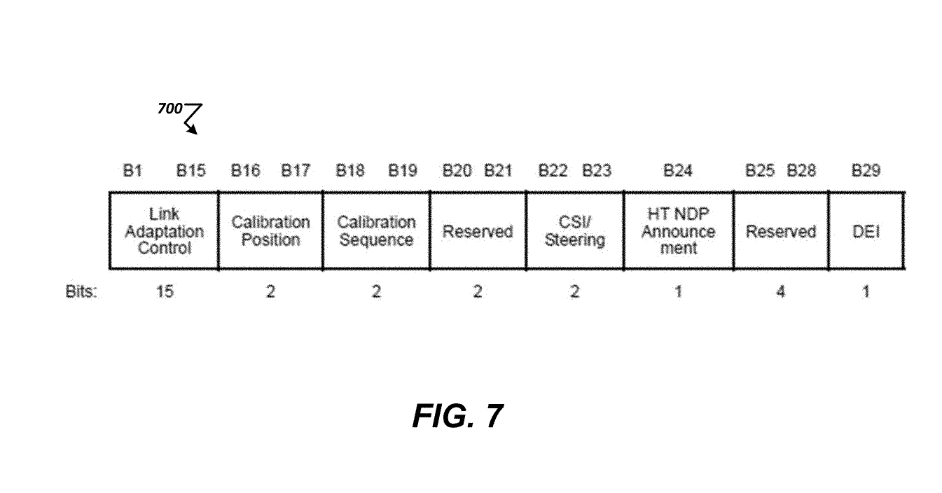

FIG. 7 is an exemplary diagram of a HT control middle subfield of a HT variant HT control field 700. The HT control field 700 can include a SR_PPDU indication subfield of one bit in length that replaces one reserved bit. For example the one of the bits B20, B21, and B25-B28 may be replaced. When the PPDU includes an SR_PPDU indication, the PPDU in which the MPDU is found is a SR_PPDU. An SR_PPDU is a PPDU that is sent by a transmitter during an SRP Opportunity. Note that adding the SR_PPDU Indication bit to HT Control Middle of the HT variant of HT Control field is optional but can be useful if HT devices are permitted to transmit SR PPDUs.

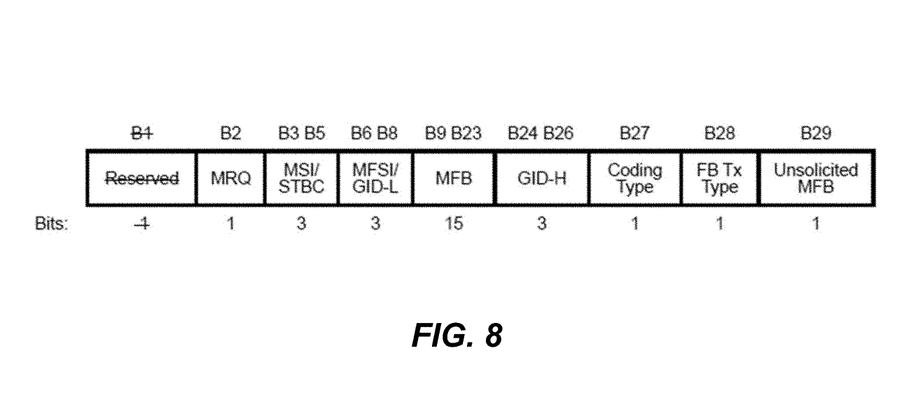

FIG. 8 is an exemplary diagram of a VHT control middle subfield of a VHT variant HT control field. The VHT variant of the HT control field can be indicated by a VHT bit of the HT control field being set to 1. Because there is a lack of a reserved bit, indicated by the strike-through of B1, the SR_PPDU Indication cannot be added to the subfield in this configuration, except when a second bit of HT Control Middle is set to 1.

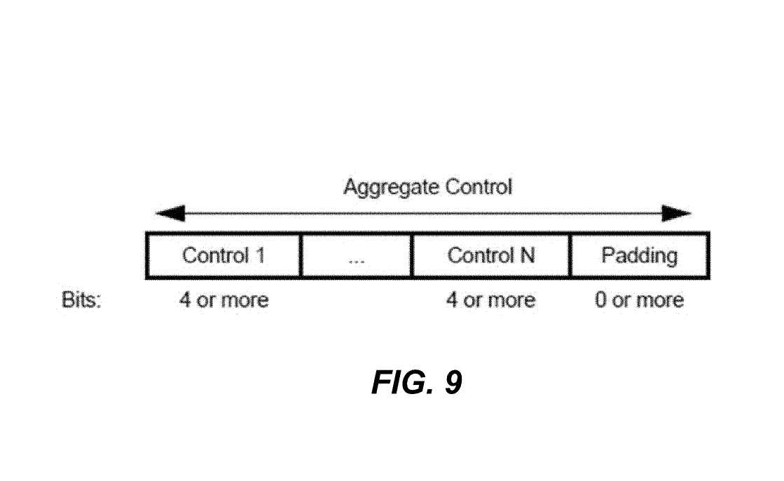

FIG. 9 is an exemplary diagram of an aggregated control (A-control) subfield of a HE variant HT control field. The A-control field may contain any of several subfields. Each of these subfields can be redefined to include the SR_PPDU Indication subfield in a formerly reserved location except for Buffer Status Report. Thus, a HE STA that identifies an SRP Opportunity and transmits a PPDU that elicits a response transmission during that SRP Opportunity includes an A-control field with the SR_PPDU Indication subfield value set to 1 in each MPDU of the PPDU that it transmits that contains an A-control field. A HE STA that receives a PPDU which contains at least one MPDU with an SR_PPDU Indication subfield value equal to 1 does not transmit a response PPDU elicited by the received PPDU if all outstanding SRP and OBSS_PD transmit power requirements are not met by the transmission.

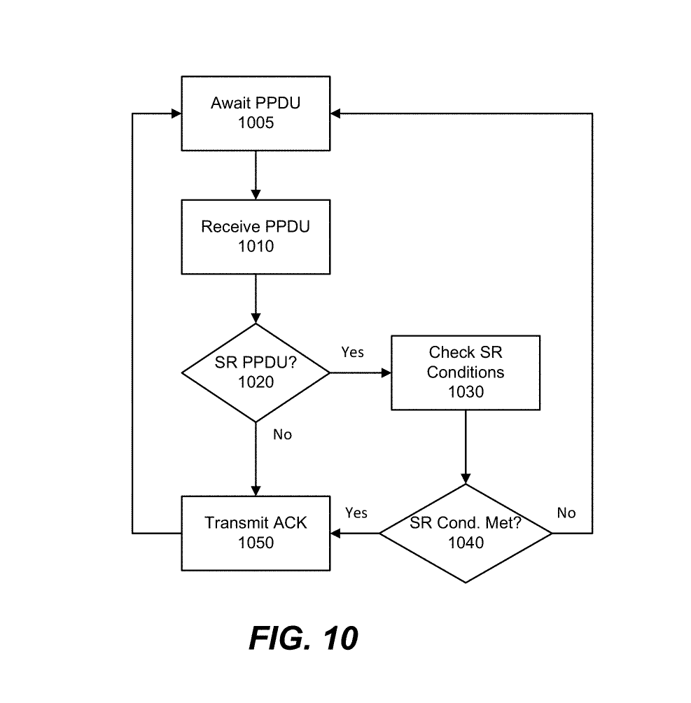

Next an exemplary SR communication process is described with reference to FIG. 10. The process in FIG. 10 begins at step 1005 where a wireless communication device awaits receipt of a PPDU. At step 1010 the PPDU is received by the wireless communication device. At step 1020 the wireless communication device determines whether the PPDU is an SR PPDU as discussed above. If the PPDU is an SR PPDU, the wireless communication device checks for SR transmission conditions at step 1030. At step 1040, the wireless communication device determines whether the SR transmission conditions are met. If the SR transmission conditions are met, the wireless communication device transmits an acknowledgement at step 1050. If, however, the wireless communication device determines at step 1040 that the SR conditions are not met, the wireless communication device does not transmit the acknowledgement and instead reverts to step 1005.

Returning to step 1020 of FIG. 10, if at step 1020 the wireless communication device determines that the PPDU is not an SR PPDU, the wireless communication device proceeds to step 1050 to transmit the acknowledgement without regard to any SR transmission condition. After transmission of the acknowledgement at step 1050, the wireless communication device reverts to step 1005 to await reception of another PPDU in order to start the process again.

Though the process in FIG. 10 is described sequentially above, the steps in FIG. 10 may be performed in other orders, including reverse order. Some or all of the steps may also be performed in parallel, and by one or more processors of the wireless communication device. The process of FIG. 10 may also be initiated through polling, such as polling a receive register to determine whether a transmission has been received, or may be interrupt-driven based on reception of data. The process may also be implemented as computer-readable instructions on a computer-readable medium, such as an electronic memory, a magnetic disk, an optical disk, etc. As such, the specific process described in FIG. 10 is merely exemplary and other variations are possible without departing from the scope of the present disclosure.

Obviously, numerous modifications and variations of the present invention are possible in light of the above teachings. It is therefore to be understood that within the scope of the appended claims, the invention may be practiced otherwise than as specifically described herein.

1. A wireless communication device comprising:
an antenna circuit to receive communications over a communication medium; and
circuitry coupled to the antenna circuit and configured to
receive, via the antenna circuit, a physical layer convergence protocol (PLCP) protocol data unit (PPDU) transmission from another device,
determine whether the PPDU transmission is a spatial reuse (SR) transmission,
determine whether one or more SR transmission conditions are met when the PPDU transmission is an SR transmission, and
transmit an acknowledgement message to the other device when the one or more SR transmission conditions are met.

2. The wireless communication device according to claim 1, wherein the circuitry is configured to transmit the acknowledgement message regardless of whether the one or more SR conditions are met, when the PPDU transmission is not an SR transmission.

3. The wireless communication device according to claim 1, wherein the circuitry is further configured to withhold transmission of the acknowledgement message when the one or more SR transmission conditions are not met and when the PPDU transmission is an SR transmission.

4. The wireless communication device according to claim 1, wherein the one or more SR transmission conditions include at least one of:
that the wireless communication device adhere to a predetermined transmit power restriction,
that physical energy detected on the communication medium indicate that the communication is not in use by another device, and
that a virtual carrier is not detected in the communication medium.

5. The wireless communication device according to claim 1, wherein the circuitry is configured to determine whether the PPDU transmission is an SR transmission based on a state of a reserved bit in the PPDU.

6. The wireless communication device according to claim 5, wherein the reserved bit is located in a high throughput (HT) control field of a media access control (MAC) frame of the PPDU.

7. The wireless communication device according to claim 6, wherein the PPDU carries payload data.

8. The wireless communication device according to claim 5, wherein the reserved bit is located in a high efficiency (HE) control field of a media access control (MAC) frame of the PPDU.

9. The wireless communication device according to claim 8, wherein the reserved bit is located in an aggregated control section of the HE control field.

10. The wireless communication device according to claim 1, wherein the wireless communication device and the other device are part of a same basic service set (BSS), and the one or more SR transmission conditions are met corresponding to interference conditions in another, different BSS.

11. A method for wireless communication, comprising:
receiving, with circuitry, a physical layer convergence protocol (PLCP) protocol data unit (PPDU) transmission from another device;
determining, with the circuitry, whether the PPDU transmission is a spatial reuse (SR) transmission;
determining, with the circuitry, whether one or more SR transmission conditions are met when the PPDU transmission is an SR transmission; and
transmitting, with the circuitry, an acknowledgement message to the other device when the one or more SR transmission conditions are met.

12. The wireless communication method according to claim 11, further comprising:
transmitting, with the circuitry, the acknowledgement message regardless of whether the one or more SR conditions are met, when the PPDU transmission is not an SR transmission.

13. The wireless communication method according to claim 11, further comprising:
withholding, with the circuitry, transmission of the acknowledgement message when the one or more SR transmission conditions are not met and when the PPDU transmission is an SR transmission.

14. The wireless communication method according to claim 11, wherein the one or more SR transmission conditions include at least one of:
that the wireless communication device adhere to a predetermined transmit power restriction,
that physical energy detected on the communication medium indicate that the communication is not in use by another device, and
that a virtual carrier is not detected in the communication medium.

15. The wireless communication method according to claim 11, further comprising:
determining, with the circuitry, whether the PPDU transmission is an SR transmission based on a state of a reserved bit in the PPDU.

16. The wireless communication method according to claim 15, wherein the reserved bit is located in a high throughput (HT) control field of a media access control (MAC) frame of the PPDU.

17. The wireless communication method according to claim 16, wherein PPDU carries payload data.

18. The wireless communication method according to claim 15, the reserved bit is located in a high efficiency (HE) control field of a media access control (MAC) frame of the PPDU.

19. The wireless communication method according to claim 18, wherein the reserved bit is located in an aggregated control section of the HE control field.

20. A non-transitory computer-readable medium encoded with computer-readable instructions that, when executed by processing circuitry, cause the processing circuitry to perform a method comprising:
receiving a physical layer convergence protocol (PLCP) protocol data unit (PPDU) transmission from a wireless communication device;
determining whether the PPDU transmission is a spatial reuse (SR) transmission;
determining whether one or more SR transmission conditions are met when the PPDU transmission is an SR transmission; and
transmitting an acknowledgement message to the wireless communication device when the one or more SR transmission conditions are met.
